(19) United States
(12) Patent Application Publication
(10) Pub. No.: US 2014/0355122 A1
(43) Pub. Date: Dec. 4, 2014

(54) Polyolefin Volumetric Diffuser

(71) Applicant: Tredegar Film Products Corporation, Richmond, VA (US)

(72) Inventors: Xueyuan Wang, Glen Allen, VA (US); Shawn R. Sheppard, Richmond, VA (US); Ravi Kalkunte, Midlothian, NC (US); Kenneth W. Walker, Semora, NC (US); Daniel M. Connor, Evans City, PA (US)

(73) Assignee: Tredegar Film Products Corporation, Richmond, VA (US)

(21) Appl. No.: 14/289,517

(22) Filed: May 28, 2014

Related U.S. Application Data
(60) Provisional application No. 61/828,170, filed on May 28, 2013.

(51) Int. Cl. G02B 5/02

(52) U.S. Cl. CPC G02B 5/02
USPC 359/599

(57) ABSTRACT

A volumetric diffuser utilizing polyolefins and light scattering particles to provide desired efficiency without hot-spots where surface texture is utilized to reduce the tendency of the polyolefin based volumetric diffuser to scratch.

### CROSS REFERENCE TO RELATED APPLICATIONS

This application claims the benefit of U.S. Provisional Patent Application No. 61/828,170, filed May 28, 2013, the contents of which are incorporated by reference herein.

### FIELD OF THE INVENTION

The present invention relates to a polyolefin based volumetric diffuser providing desired efficiency and hiding properties which providing improved resistance to scratching.

### BACKGROUND OF THE INVENTION

Diffuser structures are used in luminare as devices for distributing light over a targeted area. Such structures are placed between the light source and the viewer or between the light source and the area to be illuminated for the purpose of distributing the light in a controlled fashion as well as providing a means of hiding the light source(s) and imparting a uniform appearance to the luminaire. A diffuser providing more scattering is preferred when seeking to hide light sources inside a luminaire. Diffusers are known to achieve high hiding by using specific structures on the surface of the diffuser. Such structures include optical microstructures. U.S. Pat. No. 7,192,692B2. However, these optical microstructures result from systems that are relatively expensive and require specific polymeric resins and processing conditions to obtain consistent and functional optical microstructures.

Light Diffusers are also known to achieve diffusion by a difference in the refractive indices of resins and refractive indices of particles. U.S. Pat. No. 7,656,580B2. These are commonly called volumetric diffusers. Polyolefin resins can provide an alternative matrix for a volumetric diffuser in combination with light scattering particles. However the amount of light scattering particles present in the light diffuser polyolefin matrix has been found to result in a trade off in transmittance and the diffuser's ability to hide the light source, such that neither property can be sufficiently achieved.

The presence of a texture on the surface of the polyolefin volumetric diffuser provides benefits for light diffusion and for hiding the light source of a luminaire. However, the polyolefin materials are softer and thus more deformable compared to poly(methyl)methacrylate, polycarbonate, and polyethylene terephthalate, which are more traditionally used in lighting applications. It has been found that generally polyolefin resins are not hard enough to resist damage after texture is imparted to the surface of the polyolefin volumetric diffuser. While coatings may provide a solution to protecting textured surfaces, it is not as desired to use coatings as coating adds a separate manufacturing step and creates challenges for adhesion and stability of the final volumetric diffuser structure.

There still exists a need for a polyolefin based volumetric diffuser that provides high-efficiency, desired hiding properties while maintaining a measure of scratch resistance.

### SUMMARY OF THE INVENTION

The present invention relates to a polyolefin based volumetric diffuser comprising a top surface, a bottom surface, a thickness there between, the thickness comprising a multiplicity of light scattering particles; the top surface, the bottom surface or both the top and bottom surface of the diffuser comprises a texture, the texture being resistant to scratching.

The present invention further relates to a polyolefin based volumetric diffuser comprising a top surface, a bottom surface, a thickness there between, the thickness comprising a multiplicity of light scattering particles; the polyolefin based volumetric diffuser comprising: from about 75 wt % to about 99.9 wt %, by weight of the polyolefin based light diffuser, of the polyolefin or mixtures of polyolefins; from about 0.3 wt % to about 15 wt % by weight of the volumetric diffuser of light scattering particles; and from 0 wt % to about 10 wt % by weight of the polyolefin based light diffuser of one or more additives; wherein the top surface, the bottom surface or both the top surface and the bottom surface comprise a texture, the texture comprising a feature height and a curvature of the feature height, the curvature of the feature comprises a radii of 1 micron or more.

### BRIEF DESCRIPTION OF THE DRAWINGS

FIG. 1 shows an enlarged prospective cross-section view of the polyolefin volumetric diffuser.

FIG. 2 show an enlarged prospective cross-section view of the polyolefin volumetric diffuser with an embodiment showing one surface with partial texture on the top surface.

FIG. 3 shows the mean divergence over azimuthal angles for Example 1 without texture on either the top surface or bottom surface.

FIG. 4 shows the mean divergence over azimuthal angles for Example 1 with texture on at least one surface.

FIG. 5 shows the mean divergence over azimuthal angles for Example 2 without texture on either the top surface or bottom surface.

FIG. 6 shows the mean divergence over azimuthal angles for Example 2 with texture on at least one surface.

FIG. 7 shows the mean divergence over azimuthal angles for Examples 3 and 4.

FIG. 8 shows the mean divergence over azimuthal angles for Examples 5 and 6.

FIG. 9 shows the mean divergence over azimuthal angles for Example 7.

### DETAILED DESCRIPTION OF THE INVENTION

The polyolefin volumetric diffuser of this application is particularly useful in architectural lighting, where it is important to eliminate the “hot spots” of very bright light sources by smoothing light distribution emitted from the luminaire while maintaining a high light output (high efficiency). Applications within the scope of architectural lighting include but are not limited to spotlighting exterior walls or building facades, bridge, structure, and sign lighting; spotlighting landscape features; architectural flood lighting; accenting architectural features; interior large-area lighting; accent lighting for interior features; back lighting, cove lighting, gallery and stage lighting; and urban street lighting.

A diffuser providing higher levels of scattering is preferred to hide light sources inside a luminaire. However, one consideration in attempting to achieve a large amount of scatter is the corresponding effect upon efficiency of the diffuser as the two tend to be inversely proportional.

The polyolefin based volumetric diffuser (10) of the present application comprises a top surface (12), a bottom surface (14), a thickness (16) there between, the thickness (16) comprising a multiplicity of light scattering particles (18) dispersed therein as exemplified in FIG. 1 (enlarged). As used herein “dispersed” means distributed in a more or less even fashion within the thickness (16).

The light scattering particles (18) are present such that the light scattering particles can be characterized as being present in a grams per square meter (particle basis weight) when viewed perpendicular to a plane parallel to the top surface (12) and bottom surface (14). As the top surface (12) and/or the bottom surface (14) can comprise a texture, the plane may be distinct but parallel to the top surface (12) and the bottom surface (14). In one embodiment, the light scattering particles (18) are present at more than 10 grams per square meter when viewed perpendicular to the top surface (12) or the bottom surface (14), such as between 10 grams and 40 grams per square meter (particle basis weight) when viewed perpendicular to the top surface (12) or the bottom surface (14). In one embodiment, the light scattering particles (18) are preferably uniformly dispersed within the thickness (16). The polyolefin based volumetric diffuser (10) may be in the form of a film or sheet or may be cut from a film or sheet. A film may be dimensionally described as having a machine direction (also referred to as the x-axis direction), a cross direction (also referred to as the y-axis direction), and a thickness (z-axis direction). The machine or x-axis direction is defined by the direction in which the film passes through the manufacturing process. Typically, films are produced as long sheets or webs which have a much longer length (machine direction) than width (cross direction). If injection molding steps are utilized, the x-axis direction and the y-axis direction may be determined as appropriate.

The diffuser may comprise one or more layers, the combination of the layers together making the thickness of the diffuser. The thickness of the diffuser may be between about 3 mil (76.2 micron) and about 250 mil (350 micron), such as between about 3 mil (76.2 micron) and about 30 mil (762 micron), such as between about 3.5 mils (88.9 micron) and about 15 mils (381 micron), such as between about 4.5 mils (114.3 micron) and about 10 mils (254 micron). An embodiment suitable for use herein is to have a monolayer diffuser. The desired thickness of the diffuser may be modified while maintaining the target light scattering particle basis weight resulting in the desired range discussed above.

The top surface and/or the bottom surface of the diffuser may comprise a texture. The texture may be orientated in the machine direction (x-axis) or in the cross-direction (y-axis), with the thickness (height) of the diffuser being the direction predominately modified. Suitable modifications to the thickness (16) or the distance between the top surface (12) and the bottom surface (14), may result from formation of a feature within the thickness (16) of the diffuser (10) by the formation of one or more features, the degree of randomness of a feature, the feature height, the feature depth, the feature shape, the pitch of the feature, regularity of the feature pitch, or curvature of the feature. The top surface (12) and bottom surface (14) are more representative planes when texture is present. The height of the feature need not reach back to the top surface (12) or bottom surface (14) planes as the feature thickness (21) is associated with the thickness (16) of the diffuser. The diffuser does not comprise a coating layer that is located over the surface of the texture.

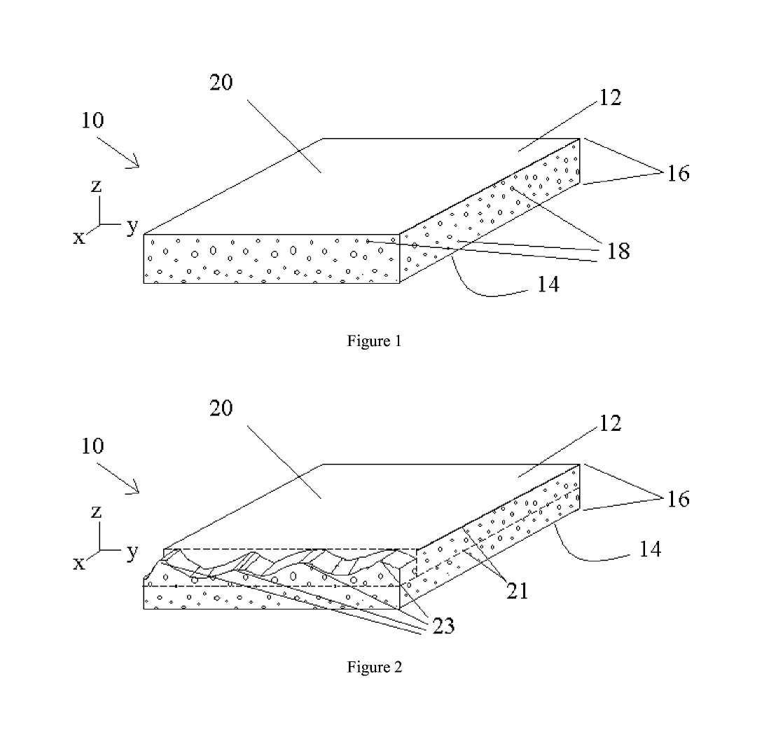

FIG. 2 (not drawn to scale) shows a magnified view of a cross-section of the diffuser (10) wherein the texture feature thickness (21) extends from the top surface (12) or from the bottom surface (14) to between about 0.5% to about 50% of the total thickness (16) of the diffuser (10), such as about 0.5% to about 10%, such as about 0.5% to about 5%, such as about 0.5% to about 1% of the total thickness (16) of the diffuser (10). A feature thickness (21) may be between 0.5% and 10% of the total thickness (16) of the diffuser (10) located in the external portions of the thickness (16) closest to the top surface (12) or the bottom surface (14). Without being limited by a theory, it is believed that the feature height and curvature (23) of the feature impart scratch resistance to the polyolefin based volumetric diffuser.

In an embodiment, the diffuser surface may have a texture of about 5 to about 250 Ra. In an embodiment, the texture is random in the machine and/or cross direction of the diffuser, the texture feature having average curvatures comprising radii larger than 6 microns, such as 7 microns or larger at the top of the height of the feature referred to herein as an average radius of curvature and measurement thereof is described below.

There are many methods of imparting controlled texture to the top and/or bottom surface, including embossing, which typically involves replicating a pattern from a hard roll onto the top and/or bottom surface, and photolithography, which is indirect and involves several intermediate steps to achieve a top and/or bottom surface with the necessary surface features. Injection molding processing may include texture in the mold utilized for the injection molding. It is believed that texture (20) to the surface of the polyolefin gives a broader overlap in acceptable efficiency (transmission as measured herein) and hiding properties of a volumetric diffuser than achieved by using light scattering particles (18) dispersed in a polyolefin matrix alone. There is a trade-off between the hiding properties compared to the efficiency of a volumetric diffuser. The effect on transmission (used herein to measure efficiency of the volumetric diffuser) by increasing the concentration of the light scattering particles (18) dispersed in a polyolefin matrix selected as polypropylene can be seen in Table 1.

TABLE 1

| | grams CaCO₃ | CaCO₃ | | |
|---|---|---|---|---|
| | per square | Content | Transmission | |
| | meter surface | wt % | Average | Standard Deviation |
| Ex. 1 | 7.1 | 5% | 87.3 | 0.44 |
| Ex. 2 | 15.0 | 10% | 83.3 | 0.62 |
| Ex. 3 | 18.4 | 12% | 78.5 | 0.72 |
| Ex. 4 | 23.6 | 15% | 74.97 | 0.25 |
| Ex. 5 | 29.2 | 18% | 69.03 | 0.46 |
| Ex. 6 | 33.0 | 20% | 70.43 | 0.84 |
| Ex. 7 | 37.0 | 22% | 64.5 | 0.36 |

Table 1 shows the transmission for a volumetric diffuser composition set forth in Table 2 below and measured as described herein below in the Testing section. As can be seen in Table 1, the increasing the weight percentage of the light scattering particles, here calcium carbonate, reduces the transmittance of the volumetric diffuser. By comparison, Examples 1-7 are tested for hiding properties, it can be seen that the increase in light scattering particles improves hiding properties. As used herein, where referring to “hiding properties” or “hiding” of the diffuser, it refers to the absence of visual “hot spots” from the light source when viewed behind the diffuser. Lack of diffraction is described as having zero-order and therefore the absence of “hot spots” can be referred to as “no zero-order”. A curve showing an inflection point or shoulder in the curve represents that a hot spot is present and the hiding properties of the volumetric diffuser is not acceptable when there is a strong hot spot.

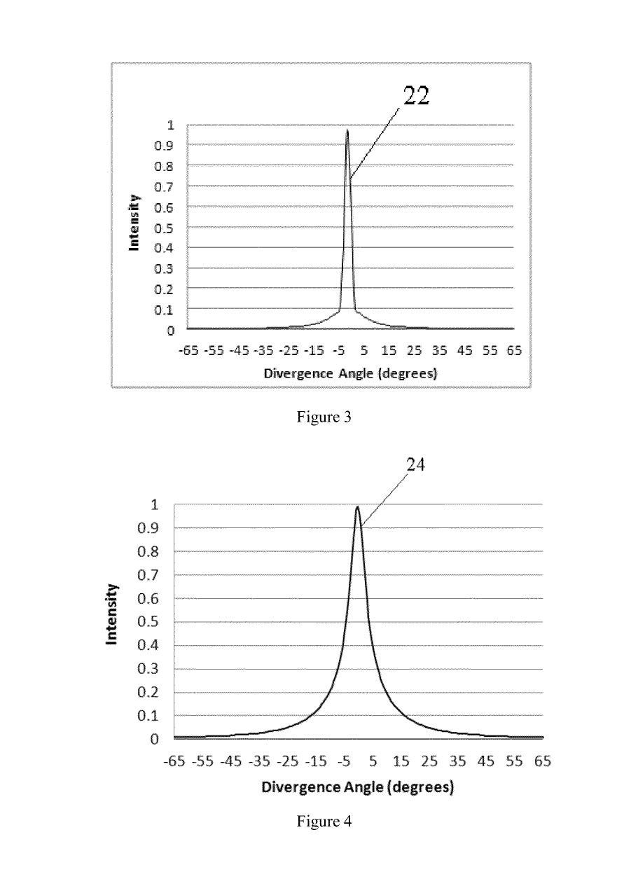

FIG. 3 shows the mean divergence over azimuthal angles for Example 1 without any surface texture (as explained below in the Testing section), with curve 22.

FIG. 4 shows the mean divergence over azimuthal angles for Example 1, with curve 24 showing Example 1 with surface texture on the top surface and the bottom surface.

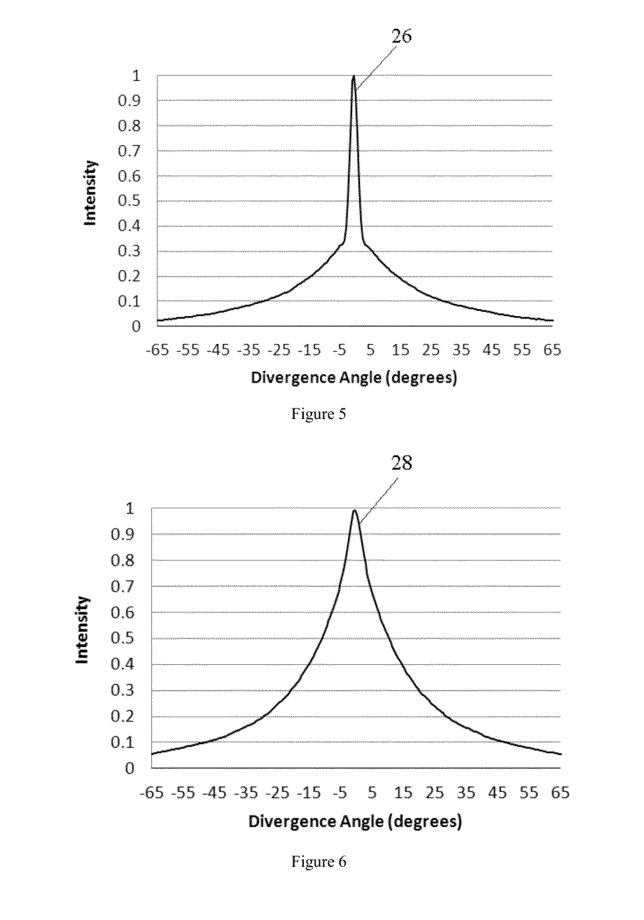

FIG. 5 shows the mean divergence over azimuthal angles for Example 2, with curve 26 showing Example 2 without any surface texture (as explained below in the Testing section).

FIG. 6 shows the mean divergence over azimuthal angles for Example 2, with curve 28 showing Example 2 with surface texture on the top surface and the bottom surface.

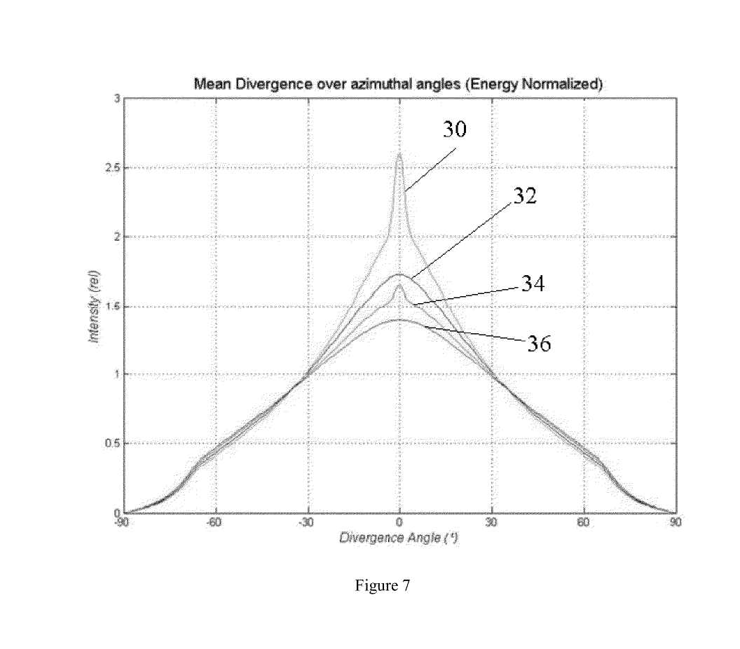

FIG. 7 shows Examples 3 and 4, with curve 30 showing Example 3 without any surface texture (as explained below in the Testing section) and curve 34 showing Example 4 without any surface texture.

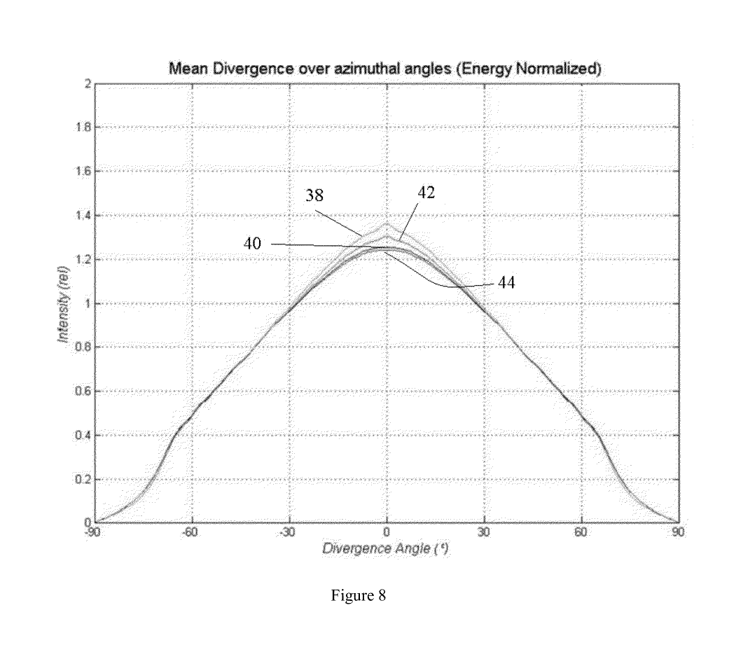

FIG. 8 shows the mean divergence over azimuthal angles for Examples 5 and 6, with curve 38 showing Example 5 without any surface texture and curve 42 showing Example 6 without any surface texture.

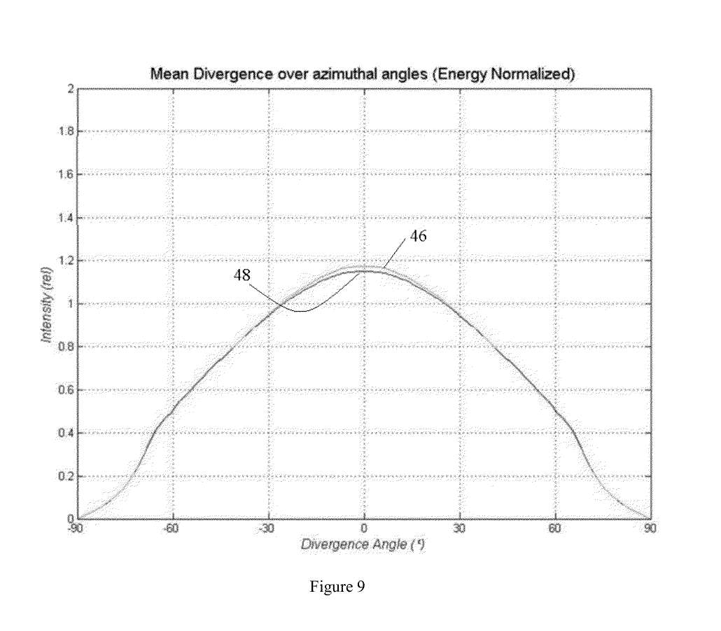

FIG. 9 shows the mean divergence over azimuthal angles for Example 7, with curve 46 showing Example 7 without any surface texture.

Curves 24, 28, 32, 36, 40, 44, 46 and 48 represent graphically the absence of a “hot spot” from the light source while viewing the light source through the volumetric diffusers of Examples 1-7 demonstrating the “no zero-order”.

Curve 46 (Example 7 without surface texture) represents a volumetric diffuser that has good hiding properties while Curves 42, 38, 34, 30, 26, and 22 show increasingly stronger hot spots which indicates poor hiding properties (Examples 6-1, respectively).

The transmission properties of Table 1 combined with Curves 24, 28, 32, 36, 40, 44, 46 and 48 demonstrate that a volumetric diffuser of Examples 1-7 improves in hiding properties by increasing the weight percentage of the light scattering particles, here exemplified by the light scattering particle being selected as calcium carbonate and the polyolefin being selected as polypropylene.

Polyolefins

Suitable resins for used in the polyolefin based light diffuser are polyolefin polymers such as polyethylene, low density polyethylene, linear low density polyethylene, high density polyethylene, medium density polyethylene, polypropylene (isotactic and syndiotactic), random copolymer polypropylene, polypropylene impact copolymers, poly(4-methyl)pentene, and polybutylene, metallocene-catalyzed polyolefins such as metallocene-catalyzed linear low density polyethylene, plastomers, cyclic olefin polymers derived from norbornene and tetracyclododecene and combinations thereof. If present, co-monomers may be randomly incorporated or present in blocks, and may be present from 0 wt % to about 30 wt %, by weight of the copolymer, such below about 25 wt %, by weight of the copolymer. The refractive index of the polyolefin is preferred to be in the range of from 1.4 to 1.65.

The designation “low density” means the polymer has a density less than about 0.930 g/cm³ and more specifically between 0.800 g/cm³ and about 0.930 g/cm³. The designation “high density” means the polymer has a density of about 0.940 g/cm³ to 0.970 g/cm³.

The polyolefin resin comprises from about 75 wt % to about 99.9 wt %, by weight of the polyolefin based light diffuser, of the polyolefin or mixtures of polyolefins.

In an embodiment, the resin comprises a polypropylene impact copolymer. A typical propylene impact copolymer contains two components, a homopolymer component (isotactic polypropylene) and a copolymer component. The copolymer component has rubbery characteristics and provides the desired impact resistance, whereas the homopolymer component provides overall stiffness. U.S. Pat. No. 6,472,474. Polypropylene impact copolymers comprise isotactic polypropylene having a high crystallinity (70-80%) and co-momomers of an alpha-olefin such as ethylene, ethylene-propylene comonomer, butylene, hexane, octene and mixtures thereof. Suitable melt flow rates for the polypropylene impact copolymer is between 2.0 and 100 g/10 min, such as 5.0 to 15. 0 g/10 min, such as 7.0 and 9.0 g/10 min (ASTM D1238) and a density of about 0.9 g/cm³. One suitable polypropylene impact copolymer is ExxonMobil 7623E1.

In an embodiment, the polyolefin resin comprises a low density polyethylene, such as low density polyethylene, linear low density polyethylene, metallocene-catalyzed linear low density polyethylene, metallocene-catalyzed plastomers and mixture thereof. The designation “low density” means the polymer has a density less than about 0.930 g/cm³ and more specifically between 0.800 g/cm³ and about 0.930 g/cm³. Metallocene-catalyzed plastomer may comprise a density between about 0.860 g/cm³ and 0.915 g/cm³ and may be ethylene-butene or ethylene-hexene plastomers. One suitable low density polyethylene is a ethylene-hexene plastomer having a density of 0.900 g/cm³ and a melt index of 3.5 g/10 min (ASTM D 1238) available as Exact™ 3131 from ExxonMobil.

Light Scattering Particles

The polyolefin based light diffuser comprises light scattering particles. Light scattering particles suitable for use herein include particles comprising between about 0.3 wt % to about 15 wt % by weight of the volumetric diffuser. The light scattering particles (18) are present such that the light scattering particles are present grams per square meter at a plane parallel to the top surface (12) or bottom surface (14). As the top surface (12) and/or the bottom surface (14) can comprise a texture, the plane may be distinct but parallel to the top surface (12) and the bottom surface (14). In one embodiment, the light scattering particles (18) are present at more than 10 grams per square meter at the top surface (12) or the bottom surface (14), such as between 10 grams and 40 grams per square meter. The weight percentage identifies a weight percentage range of light scatter particle concentration dispersed within the polyolefin matrix. As stated above, it has been found that the amount of particles does influence the transmittance properties of the volumetric diffuser and the volumetric diffuser's ability to hide the light source.

It is believed that a light scattering particle having a refractive index between 1.3 and 2.0 gives the desired transmittance properties and hiding properties of the volumetric diffuser. The refractive index of the light scattering particle is selected to be at least 0.1 different from the refractive index of the polyolefin selected. So if the polyolefin selected has a refractive index of 1.48, then the light scattering particle shall have a refractive index between 1.3 and 1.38 or between 1.58 and 2.0.

Organic Light Scattering Particles

The polyolefin based light diffuser may comprise organic light scattering particles. As stated above, it has been found that the amount of organic light scattering particles does influence the transmittance properties of the volumetric diffuser and the volumetric diffuser's ability to hide the light source.

The organic light scattering particles size comprises a mean average of between about 0.07 micron and about 30 micron, such as between about 0.2 micron and 15 microns, such as between about 0.8 micron and about 10 microns. The refractive index n of the organic particles is in the range of from 1.3 to 2.0 and selected such that the refractive index of the organic particles is different from the refractive index of the polyolefin by more than 0.1. Suitable organic particles for the organic light scattering particles include polytetrafluoroethylene (PTFE) (ex DuPont® under the tradename TEFLON® with a refractive index reported as 1.38; silicone particles with refractive index reported as 1.43; polystyrene x-linked particles with a refractive index reported as 1.59.

Inorganic Light Scattering Particles

The polyolefin based light diffuser may comprise inorganic light scattering particles. As stated above, it has been found that the amount of inorganic light scattering particles does influence the transmittance properties of the volumetric diffuser and the volumetric diffuser's ability to hide the light source.

The inorganic light scattering particles size comprises a mean average of between about 0.07 micron and about 30 micron, such as between about 0.2 micron and 15 microns, such as between about 0.8 micron and about 10 microns. Suitable inorganic particles for the inorganic light scattering particles include titanium phosphate, lead hydrogen phosphate, zinc oxide, zinc sulfide, magnesium titanate, magnesium oxysulfate, magnesium hydroxide, barium sulfate, calcium hydroxide, silica, alumina, calcium titanate, titanium dioxide, and more preferably ground calcium carbonate, precipitated calcium carbonate and any combination thereof. The refractive index n of the inorganic particles is in the range of from 1.3 to 2.0 and selected such that the refractive index of the inorganic particles is different from the refractive index of the polyolefin by more than 0.1.

The inorganic light scattering particles may comprise a coating, such coating may help improve integration into the resin or provide other properties suitable for the polyolefin based light diffuser of the present application. Suitable coatings include fatty acids, fatty acid salts, silica, alumina, sulfonated polyesters, maleic anhydride or acrylic acid-modified olefins. The inorganic light scattering particle may be supplied in a carrier such a polyolefin described above.

Additives

The polyolefin based light diffuser may comprise additives as needed. Suitable additive include nucleating agents, slip agents, anti-static agents, UV stabilizers, antioxidants, neutralizing agents, additives for scratch resistance, other processing aids and mixtures thereof. These additives may be present in amounts of 100 ppm to 6000 ppm, or more preferably 500 ppm to 5000 ppm, and incorporated into the polyolefin matrix either as neat additives or individually as a concentrate or in a masterbatch blend, or in any combination thereof. The additives may be present from 0 wt % to about 10 wt % by weight of the polyolefin based light diffuser.

The polyolefin based volumetric diffuser may also contain nucleating agents in order to increase the throughput of the manufacturing process. Nucleating agents are available in a variety of forms but all serve to increase the crystallization temperature of the polyolefin and thus allow for faster line speeds and better process uniformity. Examples of useful nucleating agents include soluble compounds, e.g., sorbitol acetals similar to those marketed by Milliken, in the quantity of 300 to 10000 ppm, more preferably 500 to 5000 ppm, more preferably 1500 to 4000 ppm; or insoluble compounds such as HPN-68L, HPN-600ei, or HPN-20E, also marketed by Milliken, and such as NA-21 and NA-11, marketed by Amfine Chemical Corporation, or more generic nucleators such as sodium benzoate or talc, in the quantity of 150 to 3500 ppm, more preferably 300 to 2000 ppm polymer. It is contemplated that two or more nucleators could be mixed as well.

Slip agents may be selected from primary and secondary unsaturated fatty acid amides. Antistat agents (antistatic agents) may be selected from primary and secondary unsaturated fatty acid amides, glycerol esters, fluorinated process aids. UV stabilizers, may include, but are not limited to benzophenones, benzotriazoles, zinc oxides, and hindered amine light stabilizers. Antioxidants may include, but are not limited to hindered phenols, secondary aromatic amines, lactone, thioesters, phosphites and phosphonites. Neutralizing agents may be used to neutralize acid residues may include, but are not limited to organic salts, hydrotalcites or alkaline metal oxides.

Additives for scratch resistance may include fatty amides, silicone polymers and mixtures thereof.

Other processing aids may include fluoropolymers, such as those available under the VITON® product line (ex. DuPont) or under the Dyneon™ product line (ex 3M™ Dyneon™)

Testing Methods

Efficiency (Transmittance)

As used herein, the efficiency of the polyolefin based volumetric diffuser is measured via transmittance. The efficiency of a sample is characterized by measuring the transmittance of a sample per ASTM D1003 on a BYK Gardner Hazegard Plus CIE-C.

Hiding Properties (No Zero Order)

As used herein, where referring to “hiding properties” or “hiding” of the diffuser, it refers to the absence of visual “hot spots” from the light source when viewed behind the diffuser. Lack of diffraction is described as having zero-order and therefore the absence of “hot spots” can be referred to as “no zero-order”. The magnitude of diffusion performed by the sample is measured using a Goniometric Radiometer Model LD8900R/S1/10. Measurements were made by rotating the detector on a radial arm of the goniometer around the light source with the sample between the light source and the detector. The detector scans though angles and measures light output as a function of angle. As discussed above, indicates that samples were “without surface texture”, the samples tested did contain texture, as discussed herein, however the texture is made optically insignificant by putting a thin layer of glycerin on the texture of the sample (hereinafter “index matched”). Texture may be present on the top surface, the bottom surface or both surfaces of the diffuser. The presence of zero-order scatter is indicated by the presence of a superimposed peak in the center of the scattering curve. See Curve 22 in FIG. 3; Curve 26 in FIG. 5, Curves 30 and 34 in FIG. 7, Curves 38 and 42 in FIG. 8. Therefore, the desired “no zero-order” or hiding properties can been seen when there is an absence of a superimposed peak in the center of the scattering curve. See Curve 24 in FIG. 4; Curve 28 in FIG. 6; Curves 32 and 36 in FIG. 7; Curves 40 and 44 in FIG. 8 and Curves 46 and 48 in FIG. 9.

Scratch Testing

Scratch testing is performed using a TMI coefficient of friction [hereafter, COF] tester 32-07-00-001 to produce a uniform rate of movement. A variable-weight stylus made from an 8d steel nail with a polished tip radius of about 527 micron. The stylus is inserted into the sled attachment holes of the COF tester. The COF tester traverse speed is set at 6 inches (15.2 cm) per minute. Weights are added to the stylus to give a total weight (stylus+removable load comprising disc-shaped rare-earth magnets) are 27.1 g (2 wt scratch) and 55.7 g (5 wt scratch). The samples are cut into 2 inch² (12.9 cm²) and fixed to a glass plate of the COF tester with the textured surface of the diffuser facing upwards. The stylus is dragged across the textured surface of the sample with both the 2 wt and the 5 wt. The scratched samples are sandwiched in foam board squares with a round, 1-inch diameter (2.54 cm diameter) viewing window such that the exposed portion of the scratched sample is inside the viewing window (the sandwiched scratched samples are herein after referred to as “specimens”).

Specimens were presented to test panel members in random order for quantification of scratch visibility for both stylus weights (2 wt and 5 wt). Panel members are asked to view the specimens by holding the specimens at arm length with a standard fluorescent light (the standard fluorescent light is located 8 feet (2.44 meters) overhead of the panel member) behind the specimen and the panel member. A rating is assigned to each specimen from 1 (no visible scratch) to 10 (highly visible scratch). Representative examples of an unscratched film (identified as a 1) and a highly visible scratch (identified as a 10) are provided for observation prior to, but not during, the panel member's observation of the specimens. Average and standard deviation for a panel of seven members was calculated and reported in Table 5.

Radius of curvature (ROC) was measured from images captured with a Keyence VK-X200 3D Laser Scanning Microscope at 6000× magnification of diffuser samples. A line profile of approximately 60 microns was generated along one diagonal of the full field of view of the image. Individual peaks (similar to 23 in FIG. 2) were selected visually from the line profile starting in the center of the field of view and radiating outward until a sample size of nine peaks was reached. The radius of curvature of each peak was determined by placing 3 points along the curvature of each peak to generate an arc that approximates the peak curvature at its maximum height. An average of the nine radii for the examples of Table 4 is reported in Table 5.

### EXAMPLES

Polyolefin based volumetric differs were prepared from compositions set forth in Table 2 using techniques typical in the manufacture of extruded cast film to a thickness of 6 mil (152.4 micron). Cast extrusion process suitable includes extruding the composition for the diffuser from a slot die onto a surface. The diffuser composition may be extruded from the same die or separate dies used in close proximity to one another in a coextrusion process. As used herein, terms “coextrusion” or “coextruding” refers to extruding two or more layers or lanes of polyolefin material from either a single die or multiple dies used in dose proximity to one another.

TABLE 2

| | | Impact | | |
|---|---|---|---|---|
| | CaCO₃ | Polypropylene | low destiny | |
| | Masterbatch¹ | Copolymer² | polyethyl- | Additives⁴ |
| | (wt %) | (wt %) | ene³ (wt %) | (wt %) |
| Ex. 1 | 6.3 | 78.5 | 7.2 | 8.0 |
| (comparative) | | | | |
| Ex. 2 | 12.5 | 73.1 | 6.4 | 8.0 |
| (comparative) | | | | |
| Ex. 3 | 15.0 | 70.9 | 6.1 | 8.0 |
| (comparative) | | | | |
| Ex. 4 | 18.8 | 67.5 | 5.7 | 8.0 |
| (comparative) | | | | |
| Ex. 5 | 22.5 | 64.3 | 5.2 | 8.0 |
| Ex. 6 | 25.0 | 62.1 | 4.9 | 8.0 |
| Ex. 7 | 27.5 | 59.9 | 4.6 | 8.0 |

¹CaCO₃ Masterbatch comprises 80% CaCO₃ in polypropylene homopolymer carrier
²Impact Polypropylene Copolymer such as that discussed herein.
³Ethylene-hexene Plastomer
⁴Antioxidant and UV stabilizer

TABLE 3
Hiding Properties

| | CaCO₃¹ | | Transmission | |
|---|---|---|---|---|
| | wt % | Surface Condition | Average | Standard Deviation |
| Ex. 1 | 5% | Texture | 87.15 | 0.19 |
| Ex. 1 | 5% | Index Matched | 87.3 | 0.44 |
| Ex. 2 | 10% | Texture | 81.98 | 0.29 |
| Ex. 2 | 10% | Index Matched | 83.3 | 0.62 |

¹The amount of CaCO₃ present in the sample is calculated as the 80 wt % by weight of the CaCO₃ Masterbatch reported in Table 2 and reported as the wt % by weight of the volumetric diffuser.

Examples 1 and 2 were measured for transmission both with and without texture on the surface of the volumetric diffuser in Table 3 to demonstrate that the addition of texture maintains efficiency. The hiding properties for Example 1 can be seen for the index matched (no texture) in FIG. 3 and with texture in FIG. 4. The hiding properties for Example 2 can be seen for the index matched (no texture) in FIG. 5 and with texture in FIG. 6.

Referring to FIGS. 7-9, Examples 3-7 were also tested for hiding properties both with and without texture (index matched).

FIG. 7 shows the mean divergence over azimuthal angles for Examples 3 and 4, with curve 32 showing Example 3 with surface texture (as explained above in the Testing section) and curve 36 showing Example 4 with surface texture. As discussed above, the presence of a shoulder in the curve represents a “hot spot” generated by a light source and unacceptable hiding properties. Curves 32 and 36 demonstrating that texture provides maintained efficiency while providing better hiding properties compared to the non-textured surface (index matched) shown in Curves 30 and 34.

FIG. 8 shows the mean divergence over azimuthal angles for Examples 5 and 6, with curve 40 showing Example 5 with surface texture and curve 44 showing Example 6 with surface texture. Example 5 without texture (index matched) is shown in curve 38 and demonstrates a slight “hot spot”. Example 6 without texture (index matched) is shown in curve 42 and demonstrates a slight “hot spot”.

FIG. 9 shows the mean divergence over azimuthal angles for Example 7, with curve 48 showing Example 7 with surface texture. Example 7 without texture (index matched) is shown in curve 46 and demonstrate acceptable hiding properties.

TABLE 4
Samples used in Scratch Analysis by Panel

| | Ex. 8 | Ex. 9 | Ex. 10 | | | |
|---|---|---|---|---|---|---|
| | (Compar- | (Compar- | (Compar- | Ex. | Ex. | Ex. |
| | ative) | ative) | ative) | 11 | 12 | 13 |
| CaCO₃ | — | — | — | 6.3 | 6.3 | 6.3 |
| Masterbatch¹ | | | | | | |
| (wt %) | | | | | | |
| Impact | — | — | 80.0 | 78.5 | 76.1 | — |
| Polypropylene | | | | | | |
| Copolymer² | | | | | | |
| (wt %) | | | | | | |
| low destiny | — | — | 20.0 | 7.2 | 11.6 | — |
| polyethylene³ | | | | | | |
| (wt %) | | | | | | |
| Additives⁴ | — | — | — | 8.0 | 6.0 | 8.0 |
| (wt %) | | | | | | |
| Polypropylene | 100.0 | — | — | — | — | 85.7 |
| Random | | | | | | |
| Copolymer⁵ | | | | | | |
| Polypropylene | — | 60.0 | — | — | — | — |
| Homopolymer⁶ | | | | | | |
| High Density | — | 40.0 | — | — | — | — |
| Polyethylene⁷ | | | | | | |

¹CaCO₃ Masterbatch comprises 80% CaCO₃ in polypropylene homopolymer carrier
²Impact Polypropylene Copolymer such as that discussed herein
³Ethylene-hexene Plastomer
⁴Antioxidant and UV stabilizer
⁵Random Polypropylene Copolymer with a density of 0.9 g/xm3; MFR of 5.0 g/10 min
⁶Polypropylene Homopolymer with a density of 0.9 g/cm3; MFR of 36 g/10 min
⁷High Density Polyethylene with a density of 0.949 g/cm3; MFR of 8.5 g/10 min

TABLE 5
Scratch Analysis by Panel

| | | | Average | |
|---|---|---|---|---|
| | 5 wt | 2 wt | ROC | |
| | scratch | scratch | (micron) | Ra (micron) |
| Ex 8 | 9.7 | 8.8 | 0.6 +/− 0.8 | 0.909 |
| (Comparative) | | | | |
| Ex 9 | 9 | 6.1 | 0.1 +/− 0.2 | 0.471 |
| (Comparative) | | | | |
| Ex 10 | 1.9 | 2 | 16.7 +/− 8.1 | 0.931 |
| (Comparative) | | | | |
| Ex 11 | 1 | 1 | 7.2 +/− 5.6 | 0.378 |
| Ex 12 | 1.4 | 1.6 | 13.5 +/− 9.9 | 0.353 |
| Ex 13 - Texture 1 | 9.9 | 9.1 | 0.8 +/− 0.2 | 3.48 |
| (comparative) | | | | |
| Ex 13 - Texture 2 | 9.6 | 8.1 | 0.8 +/− 0.4 | 2.06 |
| (comparative) | | | | |
| Ex 13 - Texture 3 | 4.7 | 2.4 | 5.2 +/− 2.2 | 0.40 |
| (comparative) | | | | |
| Ex 13 - Texture 4 | 1 | 1 | 7.0 +/− 3.7 | 0.03 |
| Ex 13 - Texture 5 | 9.3 | 9 | 0.4 +/− 0.1 | 1.24 |
| (comparative) | | | | |
| Ex 13 -Texture 6 | 9.4 | 9 | 0.6 +/− 0.2 | 1.55 |
| (comparative) | | | | |

Examples 8 and 9 are comparative examples demonstrating that the use of polyolefins such as polypropylene or a mixture of polypropylene and polyethylene to form a diffuser are identified by the panel as being scratched, correlates to a relatively small radius of curvature (ROC). Example 10 is a comparative example to show that the presence or absence of light scattering particles does not impact the scratch resistance of the diffuser. Examples 11,12 and 13, Texture 4 show that the panel found that diffuser that were not scratched correlates to a ROC of greater than 6.0 microns. Example 13, Textures 1-6 further demonstrate that the surface roughness measured in Ra (microns) does not correlate to the ROC and scratch resistance. Example 13, Texture 4 shows the desired scratch resistance with the ROC above 6.0 microns while Example 13, Texture 3 did not show the desired scratch resistance with a ROC below 6.0 microns.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “2.44 meters” is intended to mean “about 2.44 meters.”

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A polyolefin based volumetric diffuser comprising a top surface, a bottom surface, a total thickness there between, the total thickness comprising a multiplicity of light scattering particles; the top surface, the bottom surface or both the top and bottom surface of the diffuser comprises a texture, the texture being resistant to scratching.

2. The polyolefin based volumetric diffuser of claim 1 wherein the diffuser does not comprise a coating.

3. The polyolefin based volumetric diffuser of claim 1 wherein the polyolefin is selected from the group comprising polyethylene, low density polyethylene, linear low density polyethylene, high density polyethylene, medium density polyethylene, polypropylene, random copolymer polypropylene, polypropylene impact copolymers, poly(4-methyl)pentene, and polybutylene, metallocence-catalyzed polyolefins.

4. The polyolefin based volumetric diffuser of claim 1 wherein the polyolefin comprises a refractive index of from 1.4 to 1.65.

5. The polyolefin based volumetric diffuser of claim 1 wherein the texture comprises an average radius of curvature of larger than 6 microns.

6. The polyolefin based volumetric diffuser of claim 1 wherein the texture comprises a texture thickness, the texture thickness comprising between about 0.5% and about 10% of the total thickness located at the top surface, bottom surface or both.

7. The polyolefin based volumetric diffuser of claim 1 wherein the light scattering particles size comprises a mean average of between about 0.07 micron and about 30 micron

8. The polyolefin based volumetric diffuser of claim 1 wherein the light scattering particles are inorganic light scattering particles comprising a refractive index between 1.3 and 2.0.

9. The polyolefin based volumetric diffuser of claim 1 wherein the light scattering particles are present from about 10 grams and about 40 grams per square meter of the polyolefin based volumetric diffuser.

10. The polyolefin based volumetric diffuser of claim 1 wherein the light scattering particles are organic light scattering particles selected from polytetrafluoroethylene (PTFE); silicone particles; polystyrene x-linked particles.

11. The polyolefin based volumetric diffuser of claim 1 wherein the light scattering particles are inorganic selected from the group consisting of titanium phosphate, lead hydrogen phosphate, zinc oxide, zinc sulfide, magnesium titanate, magnesium oxysulfate, magnesium hydroxide, barium sulfate, calcium hydroxide, silica, alumina, calcium titanate, titanium dioxide, and more preferably ground calcium carbonate, precipitated calcium carbonate and any combination thereof.

12. The polyolefin based volumetric diffuser of claim 1 wherein the light scattering particles are organic light scattering particles comprising a refractive index between 1.3 and 2.0.

13. The polyolefin based volumetric diffuser of claim 1 wherein the polyolefin comprises a refractive index and the light scattering particles comprise a refractive index between 1.3 and 2.0, wherein the light scattering particle has a refractive index that is different from the polyolefin by at least 0.1.

14. A polyolefin based volumetric diffuser comprising a top surface, a bottom surface, a thickness there between, the thickness comprising a multiplicity of light scattering particles; the polyolefin based volumetric diffuser comprising:
(a) from about 60 wt % to about 99.9 wt %, by weight of the polyolefin based light diffuser, of the polyolefin or mixtures of polyolefins;
(b) from about 0.3 wt % to about 15 wt % by weight of the volumetric diffuser of light scattering particles; and
(c) from 0 wt % to about 10 wt % by weight of the polyolefin based light diffuser of one or more additives;
wherein the top surface, the bottom surface or both the top surface and the bottom surface comprise a texture, the texture comprising a feature height and a curvature of the feature height, the curvature of the feature comprises a radii of 6 micron or more.

15. The polyolefin based volumetric diffuser of claim 14 wherein the diffuser does not comprise a coating.

16. The polyolefin based volumetric diffuser of claim 14 wherein the polyolefin is selected from the group comprising polyethylene, low density polyethylene, linear low density polyethylene, high density polyethylene, medium density polyethylene, polypropylene, random copolymer polypropylene, polypropylene impact copolymers, poly(4-methyl)pentene, and polybutylene, metallocence-catalyzed polyolefins.

17. The polyolefin based volumetric diffuser of claim 14 wherein the polyolefin comprises a refractive index of from 1.4 to 1.65.

18. The polyolefin based volumetric diffuser of claim 14 wherein the texture comprises a texture thickness, the texture thickness comprising between about 0.5% and about 10% of the total thickness located at the top surface, bottom surface or both.

19. The polyolefin based volumetric diffuser of claim 14 wherein the light scattering particles size comprises a mean average of between about 0.07 micron and about 30 micron

20. The polyolefin based volumetric diffuser of claim 14 wherein the light scattering particles are inorganic light scattering particles comprising a refractive index between 1.3 and 2.0.

21. The polyolefin based volumetric diffuser of claim 20 wherein the inorganic light scattering particles are selected from the group consisting of titanium phosphate, lead hydrogen phosphate, zinc oxide, zinc sulfide, magnesium titanate, magnesium oxysulfate, magnesium hydroxide, barium sulfate, calcium hydroxide, silica, alumina, calcium titanate, titanium dioxide, and more preferably ground calcium carbonate, precipitated calcium carbonate and any combination thereof.

22. The polyolefin based volumetric diffuser of claim 14 wherein the light scattering particles are organic light scattering particles comprising a refractive index between 1.3 and 2.0.

23. The polyolefin based volumetric diffuser of claim 14 wherein the light scattering particles are organic light scattering particles selected from polytetrafluoroethylene (PTFE); silicone particles; polystyrene x-linked particles.

24. The polyolefin based volumetric diffuser of claim 14 wherein the polyolefin comprises a refractive index and the light scattering particles comprise a refractive index between 1.3 and 2.0, wherein the light scattering particle has a refractive index that is different from the polyolefin by at least 0.1.
